(19) United States
(12) Patent Application Publication
(10) Pub. No.: US 2026/0126595 A1
(43) Pub. Date: May 7, 2026

(54) FIBER OPTIC CONNECTOR CLEANING DEVICES

(71) Applicant: Senko Advanced Components, Inc., Hudson, MA (US)

(72) Inventors: Siu Kei MA, Kowloon (HK); Jimmy CHANG, Sturbridge, MA (US); Yohei OMODAKA, Wayland, MA (US)

(21) Appl. No.: 19/381,218

(22) Filed: Nov. 6, 2025

Related U.S. Application Data
(60) Provisional application No. 63/716,892, filed on Nov. 6, 2024.
(60) Provisional application No. 63/716,860, filed on Nov. 6, 2024.

(51) Int. Cl. G02B 6/38; B08B 1/40

(52) U.S. Cl. CPC G02B 6/3866; B08B 1/40; B08B 2240/02

(57) ABSTRACT

Cleaning devices for cleaning fiber optic connectors are disclosed. In one example, a cleaning device housing has a connector port to receive a fiber optic connector having a ferrule, and a gel holder with an insert is positioned within the device housing with cleaning gel supported on the insert to contact the ferrule. An adjustable activation member can activate the gel holder to enable the gel holder to move relative to the device housing to engage the cleaning gel with the ferrule of the fiber optic connector mated with the connector port for cleaning. Another cleaning device has a device housing with a plug portion insertable into one an adapter. The device housing has an internal gel seat that fits inside the adapter. A cleaning gel seated on the internal gel seat contacts a ferrule of a fiber optic connector inserted into an opposite end of the fiber optic adapter.

### CROSS-REFERENCE TO RELATED APPLICATIONS

This application claims priority to U.S. Provisional Application Nos. 63/716,860 and 63/716,892, both filed Nov. 6, 2024, which are hereby incorporated by reference in their entireties.

### FIELD

The present disclosure relates to fiber optic connector cleaning devices.

### BACKGROUND

Fiber optic communication systems have become widespread in telecommunications networks due to their ability to transmit large volumes of data over long distances with minimal signal loss. These systems rely on precise optical connections between fiber optic connectors to maintain signal integrity and network performance. However, contamination of connector end faces by dust, dirt, oil, and other particles can significantly degrade optical transmission quality, leading to increased insertion loss, higher return loss, and potential network outages. Various cleaning methods have been developed to address connector contamination, including wet cleaning techniques using solvents and dry cleaning approaches utilizing specialized cleaning tools such as cassette cleaners and pen-type cleaners. While these cleaning solutions have improved connector maintenance practices, challenges remain in providing convenient, effective cleaning methods that can be easily deployed in field environments and manufacturing facilities where fiber optic connectors may be exposed to contaminants during handling, storage, and installation processes.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, a cleaning device for cleaning fiber optic connectors comprises a device housing having a connector port configured to receive a fiber optic connector having a ferrule. A gel holder comprises an insert positioned within the device housing. A cleaning gel is supported on the insert and configured to contact the ferrule. An adjustable activation member is configured to be adjusted to activate the gel holder to enable the gel holder to move relative to the device housing to engage the cleaning gel with the ferrule of the fiber optic connector mated with the connector port for cleaning.

In another aspect, a cleaning device for cleaning fiber optic connectors comprises a device housing having a plug portion configured to be inserted into one end of a fiber optic adapter. The device housing comprises an internal gel seat configured to be received inside the fiber optic adapter when the plug portion is inserted into the fiber optic adapter. A cleaning gel is positioned within the internal gel seat and configured to contact a ferrule of a fiber optic connector inserted into an opposite end of the fiber optic adapter when the plug portion is inserted into the fiber optic adapter.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a perspective of a cleaning device;

FIG. 2 is a perspective of the cleaning device connected to a fiber optic connector;

FIG. 3 is an exploded perspective of the assembly in FIG. 2;

FIG. 4 is a perspective of a gel holder of the cleaning device;

FIG. 5 is a perspective of a device housing of the cleaning device;

FIG. 6 is an elevation of the assembly in FIG. 2;

FIG. 7 is a cross section taken in the plane of line 7-7 of FIG. 6;

FIG. 8 is a perspective showing removal of an activation strip of the cleaning device;

FIG. 9 is a perspective showing a head of the gel holder being pressed to clean the fiber optic connector connected to the cleaning device;

FIG. 10 a perspective similar to FIG. 9 but showing the device housing in cross section to reveal internal components;

FIG. 11 is a cross section of the scene in FIG. 9;

FIG. 12 is a perspective showing disconnection of the fiber optic connector from the cleaning device after cleaning;

FIG. 13 is a perspective of another embodiment of a cleaning device;

FIG. 14 is an exploded perspective of the cleaning device of FIG. 13;

FIG. 15 is a perspective of the cleaning device of FIG. 13 with a dust cap removed;

FIG. 16 is a perspective of the cleaning device of FIG. 13 connected to the fiber optic connector;

FIG. 17 is an enlarged perspective of the assembly in FIG. 16 showing a device housing in cross section to reveal internal components;

FIG. 18 is a perspective of the cleaning device of FIG. 13 connected to the fiber optic connector, showing during an active cleaning stage.

FIG. 19 is an enlarged perspective of the scene in FIG. 18 showing the device housing in cross section to reveal internal components during the active cleaning stage;

FIG. 20 is a perspective of another embodiment of a cleaning device;

FIG. 21 is another perspective of the cleaning device of FIG. 20;

FIG. 22 is a perspective showing a fiber optic connector mated with an adapter and the cleaning device of FIG. 20 in exploded view;

FIG. 23 is a perspective of a device housing of the cleaning device of FIG. 20;

FIG. 24 is a perspective of a lock of the cleaning device of FIG. 20;

FIG. 25 is an elevation of the lock;

FIG. 26 is a perspective of the fiber optic connector mated with the adapter and the cleaning device of FIG. 20 approaching the adapter;

FIG. 27 is a perspective of the fiber optic connector mated with the adapter and the cleaning device of FIG. 20 inserted into the opposite end of the adapter;

FIG. 28 is an enlarged perspective depicting the fiber optic connector and cleaning device of FIG. 20 inserted into opposite ends of the adapter with the lock in an extended position, showing the adapter in cross section to reveal internal components;

FIG. 29 is an enlarged perspective depicting the fiber optic connector and cleaning device of FIG. 20 inserted into opposite ends of the adapter with the lock in a retracted position, showing the adapter in cross section to reveal internal components;

FIG. 30 is a perspective showing the cleaning device of FIG. 20 with a lid opened to expose a second cleaning gel in an external gel seat and showing a fiber optic connector approaching the external gel seat; and

FIG. 31 is a perspective showing the fiber optic connector being cleaned by the second cleaning gel in the external gel seat.

Reference numerals in the drawings correspond to like elements in the detailed description. Such reference numerals are used to facilitate an understanding of the disclosure and are not intended to be limiting.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Fiber optic connectors may be subject to contamination from dirt, dust, and other particles that can accumulate on connector surfaces during storage, handling, and installation. Such contamination may affect the transmission quality of optical signals passing through fiber optic connections. In some cases, contaminated connectors may cause increased signal loss, higher insertion loss, increased reflection, and potential network performance degradation or outages.

Cleaning of fiber optic connectors may be performed using various methods, including dry cleaning and wet cleaning techniques. Dry cleaning methods may utilize cleaning devices such as cassette cleaners and pen cleaners that provide convenient and effective cleaning solutions. However, maintaining cleanliness of fiber optic connectors during storage and shipping may present additional challenges.

The present disclosure describes cleaning devices configured to clean fiber optic connector ferrules using cleaning gel. The cleaning devices may provide effective cleaning solutions for removing contaminants from fiber optic connector surfaces. The cleaning devices described herein may incorporate various mechanisms for activating cleaning operations and positioning cleaning gel in contact with connector ferrules. Some cleaning devices may include adjustable activation members that allow users to control when cleaning gel contacts the ferrule surface. Other cleaning devices may be configured to interface with fiber optic adapters to provide cleaning functionality during connector mating operations. The figures show exemplary embodiments of cleaning devices configured for cleaning fiber optic connectors. The cleaning devices may include various configurations and mechanisms for delivering cleaning gel to connector ferrules and providing effective contamination removal.

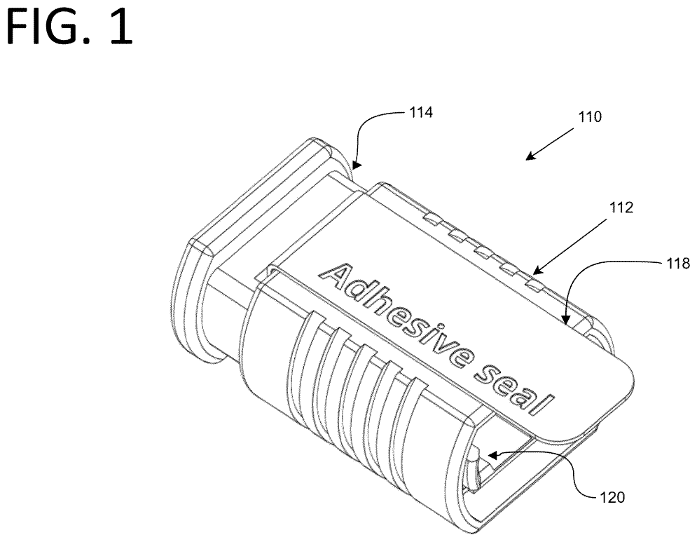

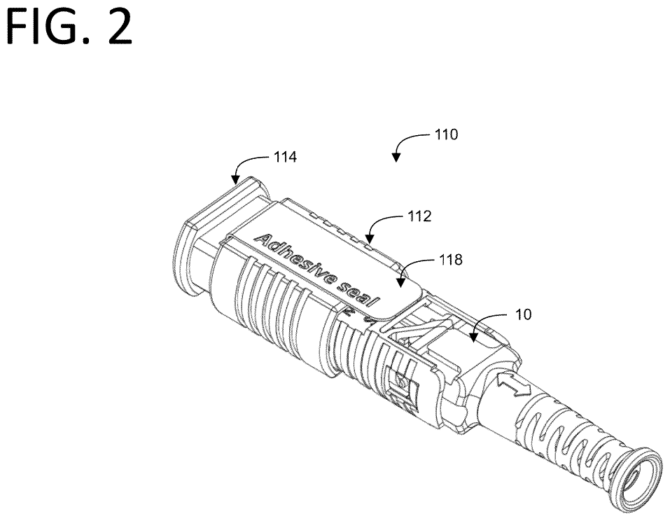

Referring to FIGS. 1-3, one example of a cleaning device in accordance with the present disclosure is generally indicated at reference number 110. The cleaning device 110 is configured for cleaning the end face of a multifiber ferrule 12 in an MPO fiber optic connector 10, but it will be understood that the principles of the cleaning device 110 described herein can also be adapted for use with other types of fiber optic connectors.

The cleaning device 110 comprises a device housing 112, a gel holder 114 positioned within the device housing 112, cleaning gel 116 supported on the gel holder, and an activation member 118 that is adjustable to selectively activate the cleaning device to enable advancement of the gel holder 114 and cleaning gel into engagement with the end face of the ferrule 12. In the illustrated embodiment, the activation member 118 is an activation strip.

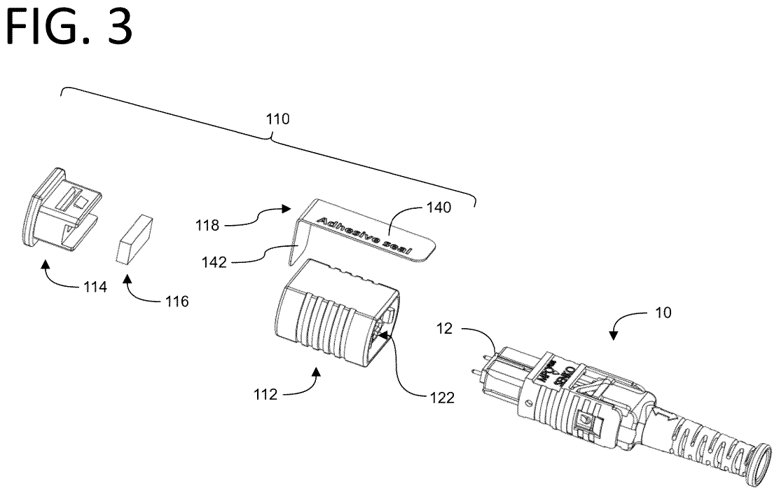

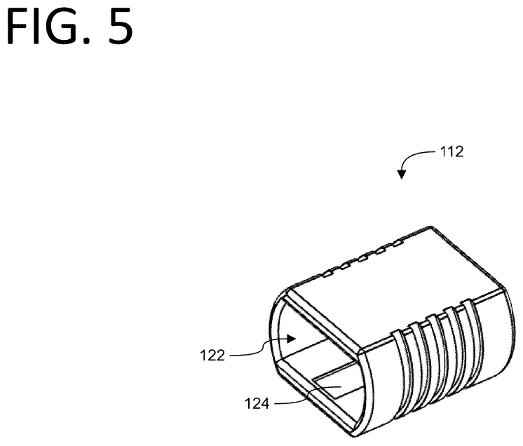

Referring to FIGS. 3 and 5, the device housing 112 has a generally tubular shape with a rectangular perimeter wall that extends longitudinally between first and second ends. The device housing 112 defines a connector port 120 at the first end configured to mate with a fiber optic connector 10. In one or more embodiments, the connector port 120 has intermateable latching features (e.g., MPO latching features) suitable for the connector 10 being cleaned. At the opposite second end, the device housing 112 defines a cleaning port 122 configured to receive the gel holder 114 and the cleaning gel 116. A retention groove 124 is formed on an inner wall of the device housing 112 and extends longitudinally from a closed end adjacent the cleaning port 122. As will be explained below, the retention groove 124 is configured to receive and engage with components of the gel holder 114.

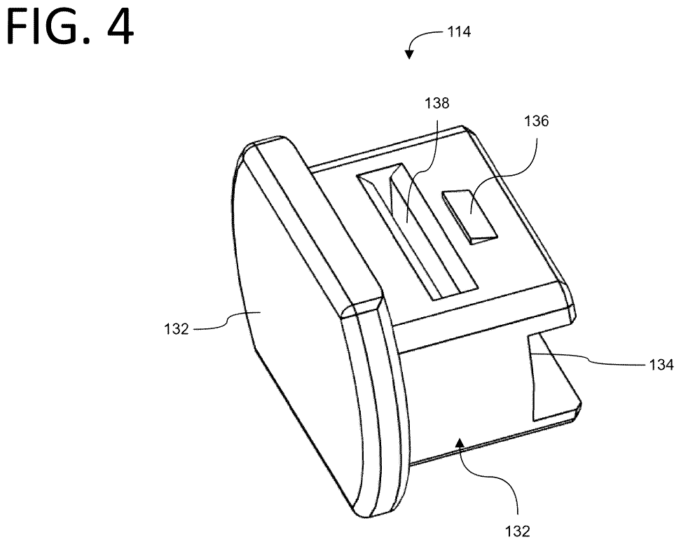

Referring to FIG. 4, the gel holder 114 has a length extending from a first end to a second end. The gel holder 114 includes an insert 130 at the first end, and a larger head 132 at the second end. The tip region of the insert 130 defines a gel seat 134 for receiving and supporting the cleaning gel 116. In use, the insert 130 is configured to be inserted into the cleaning port 122 of the device housing 112 and the head 132 is configured to reside external to the device housing 112. Latch protrusions 136 protrude from upper and lower sides of the insert 130 at locations longitudinally inset from the gel seat 134. (Only the upper latch protrusion 136 is visible in FIG. 4). When the insert 130 is inserted into the cleaning port 122, the latch protrusions 136 are configured to slidably engage the retention groove 124 to retain the gel holder 114 on the device housing 112. An activation slot 138 is formed in the insert 130 adjacent to and inset from the latch protrusion 136. The activation slot 138 is configured to removably receive a portion of the activation strip 118, as will be explained in further detail below. During use, when the activation strip 118 is received in the activation slot 138, the activation strip 118 retains the gel holder 114 at an inactive, non-cleaning position. When the activation strip 118 is removed, it activates the gel holder so it can advance relative to the device housing 112 to a cleaning position in which the gel holder 114 engages the cleaning gel 116 with the end face of the ferrule 12 of the fiber optic connector 10 mated with the connector port 120 for cleaning the ferrule 12.

The activation strip 118 is broadly configured to be adjusted to activate the gel holder 114 and enable movement of the gel holder 114 relative to the device housing 112. The activation strip 118 includes a locking portion 142 configured to be received in the activation slot 138 to restrict movement of the gel holder 114 relative to the device housing 112 until cleaning is desired (FIG. 3). The activation strip 118 also includes a pull tab 140 connected to the locking portion 142 at a bend. In the illustrated example, the locking portion 142 and the pull tab 140 are oriented perpendicular to one another. The pull tab 140 suitably extends longitudinally along the upper wall of the device housing 112 in the illustrated embodiment. In certain embodiments, a portion of the activation strip 118 (e.g., the locking portion 142 and/or the pull tab 140) can include a temporary adhesive that holds the activation strip 118 in place relative to the gel holder 114 and/or device housing 112. If adhesive is used, it is envisioned that it is a peelable type of adhesive that permits separation of the activation strip when a user grips and pulls the pull tab 140. The activation strip 118 is configured to enable activation of the gel holder 114 by pulling the pull tab 140 to withdraw the locking portion 142 from the activation slot 138, thereby allowing the gel holder 114 to move from an inactive position to an active cleaning position.

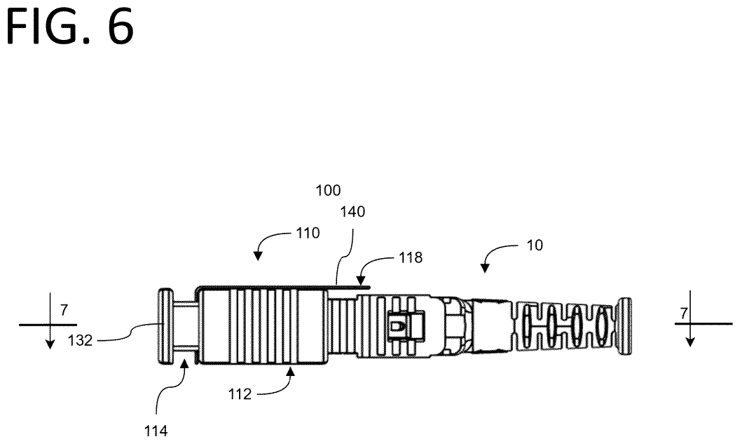

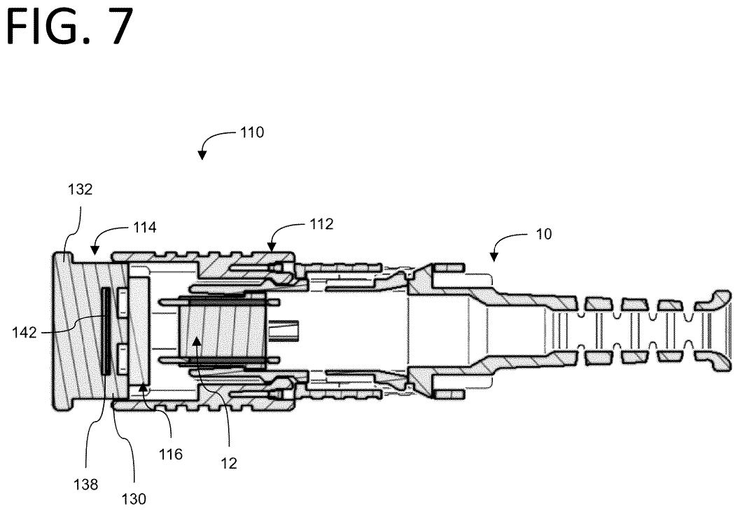

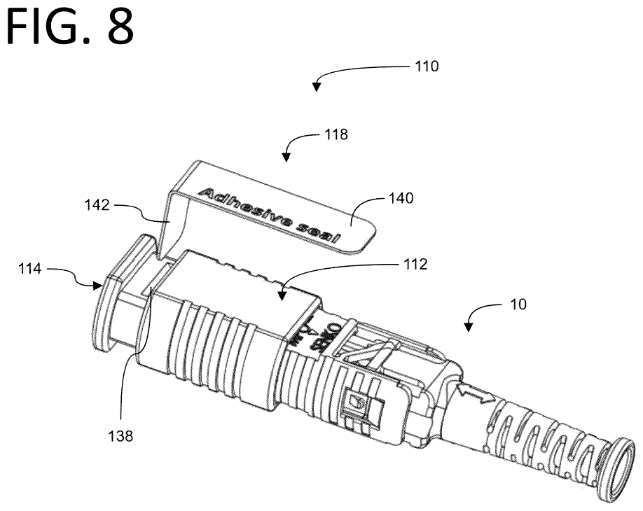

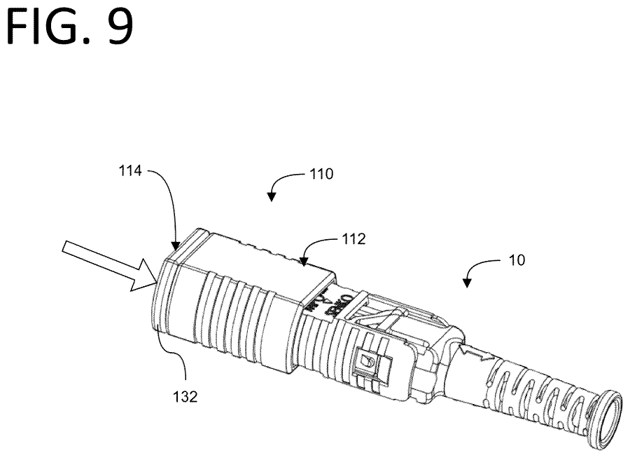

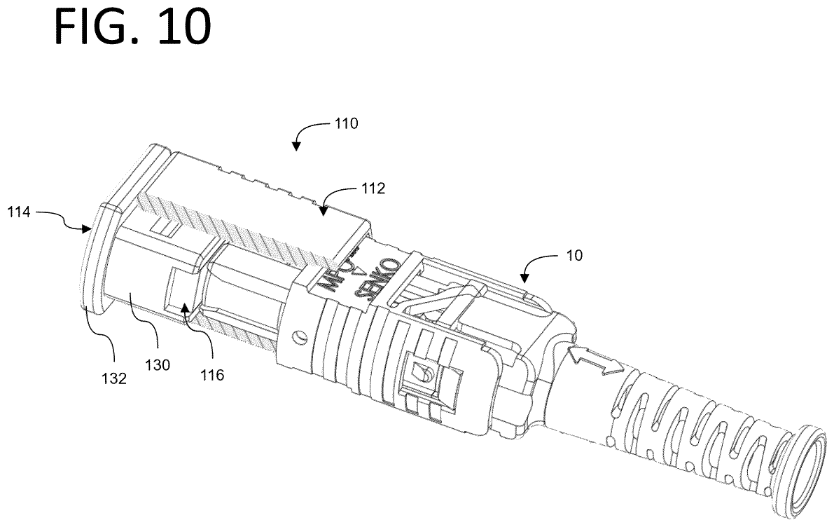

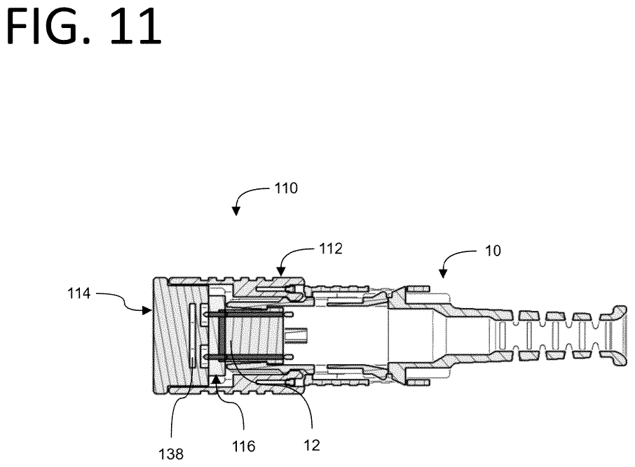

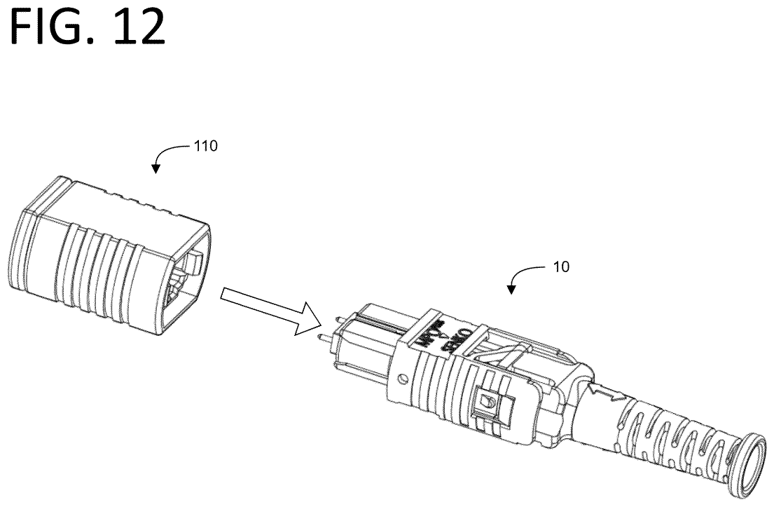

An example method of using the cleaning device 110 will now be described. Referring to FIGS. 6 and 7, the cleaning device 110 is assembled with the gel holder 114 and cleaning gel 116 positioned in the cleaning port 122 and the locking portion 142 of the activation strip 118 received in the activation slot 138. An operator begins the cleaning process by inserting the fiber optic connector 10 into the connector port 120. In the inactive position, the locking portion 142 is received in the activation slot 138 to inhibit movement of the gel holder 114. In this position, the ferrule 12 and guide pins are separated longitudinally from the cleaning gel 116. Referring to FIG. 8, the operator activates the cleaning process by pulling the pull tab 140 to withdraw the locking portion 142 from the activation slot 138. Referring to FIGS. 9-11, the operator then presses the head 132 to move the gel holder 114 longitudinally relative to the device housing 112. The gel holder 114 moves such that the insert 130 contacts the front end of the device housing 112 and the cleaning gel 116 engages the ferrule 12 and guide pins of the fiber optic connector 10 for cleaning. After cleaning is complete, the operator removes the fiber optic connector 10 from the connector port 120, with the connector now cleaned and ready for use, as shown in FIG. 12.

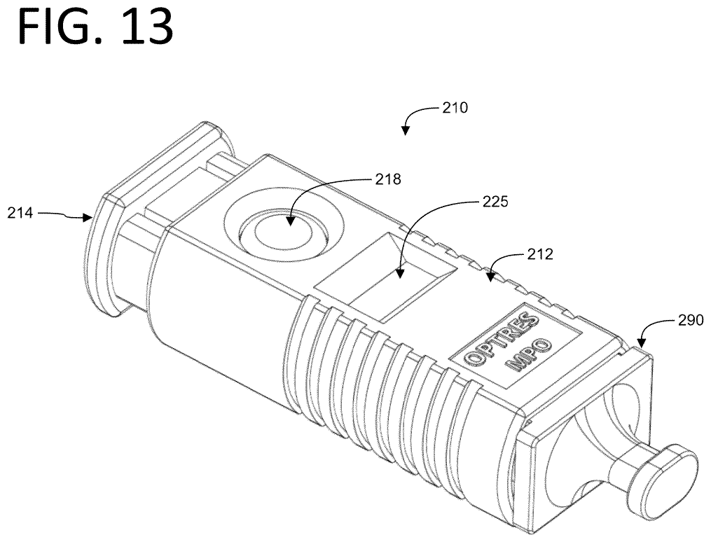

Referring to FIGS. 13-16, another example of a cleaning device in accordance with the present disclosure is generally indicated at reference number 210. The cleaning device 210 is configured for cleaning the end face of a multifiber ferrule 12 in an MPO fiber optic connector 10 and SC fiber optic connectors 10, but it will be understood that the principles of the cleaning device 210 described herein can also be adapted for use with other types of fiber optic connectors.

Like the cleaning device 110, the cleaning device 210 comprises a device housing 212, a gel holder 214 positioned within the device housing 212, cleaning gel 216 supported on the gel holder. An adjustable activation member is adjustable to selectively activate the cleaning device 110 to enable advancement of the gel holder 214 and cleaning gel 216 into engagement with the end face of the ferrule 12. In the illustrated embodiment, the adjustable activation member comprises an activation button 218.

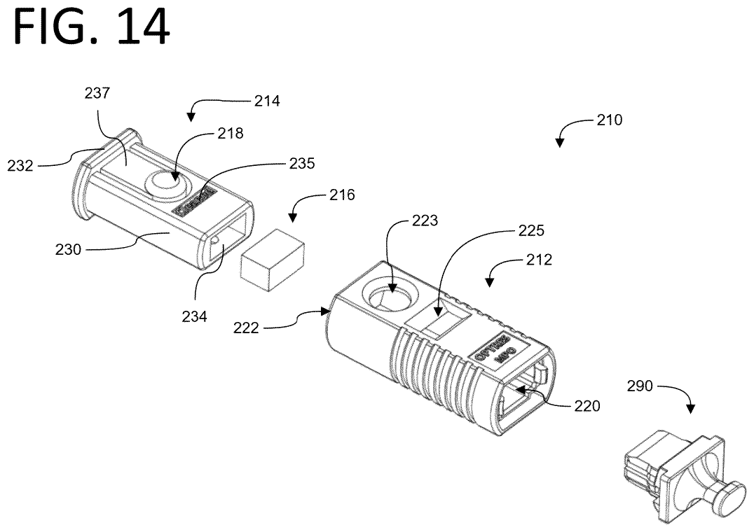

Referring to FIG. 14, the device housing 212 is generally tubular and has a rectangular, upper perimeter wall that extends longitudinally between first and second ends. The device housing 212 defines a connector port 220 at the first end configured to mate with the fiber optic connector 10. In one or more embodiments, the connector port 220 has intermateable latching features (e.g., MPO latching features) suitable for the connector 10 being cleaned. At the opposite second end, the device housing 212 defines a cleaning port 222 configured to receive the gel holder 214 and the cleaning gel 216. The device housing 212 includes a button opening 223 formed in the upper perimeter wall and configured to receive the activation button 218. A viewing window 225 is formed in the device housing 212 to allow observation of internal components during cleaning operations. A dust cap 290 is configured to cover the connector port 220 when the cleaning device 210 is not in use.

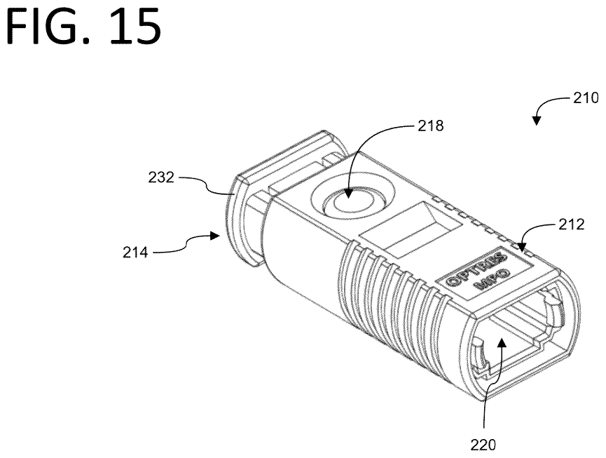

Referring to FIGS. 14 and 15, the gel holder 214 has a length extending from a first end to a second end. The gel holder 214 includes an insert 230 at the first end configured to be inserted into the cleaning port 222 of the device housing 212. At the opposite end, the gel holder 214 has a larger head 232 configured to be external to the cleaning port 222. The insert 230 includes a gel seat 234 configured to receive and position the cleaning gel 216. The tip region of the insert 230 defines a gel seat 234 for receiving and supporting the cleaning gel 216. In use, the insert 230 is configured to be inserted into the cleaning port 222 of the device housing 212 and the head 232 is configured to reside external to the device housing 212.

The cleaning gel 216 is positioned within the gel seat 234 and is configured to contact the ferrule 12 of the fiber optic connector 10 during cleaning operations. The cleaning gel 216 provides effective removal of contaminants from the end face of the ferrule 12.

Referring to FIG. 14, the gel holder 214 comprises a button arm 237 supporting the activation button 218. The button arm 237 is bendable to allow transverse movement of the activation button 218. The activation button 218 includes a height dimension that prevents movement of the gel holder 214 when received in the button opening 223 or the button opening 224. The activation button 218 is configured to be depressed transversely to unlatch from the button opening 223 or the button opening 224 and allow longitudinal movement of the gel holder 214 relative to the device housing 212 for cleaning.

A cleaning status indicator 235 is formed on the top wall of the gel holder 214. In this embodiment, the activation button 218 is located longitudinally between the cleaning status indicator 235 and the head 232. During use, when the cleaning device 210 is actively cleaning the ferrule 12 (e.g., pressing the cleaning gel 216 into contact with the ferrule 12), the cleaning status indicator 235 is visible through the viewing window 225. By contrast, when the activation button 218 is latched with the button opening 223 (meaning the gel holder 214 is positioned at an inactive position where the cleaning gel 216 cannot contact the end face of the ferrule 12 mated in the connector port 220), the cleaning status indicator 235 is concealed by the upper wall of the device housing 212 and is not visible through the viewing window 225. The cleaning status indicator 235 provides visual feedback to indicate when the cleaning device 210 is in an active cleaning state and when cleaning gel 216 is in contact with the ferrule 12.

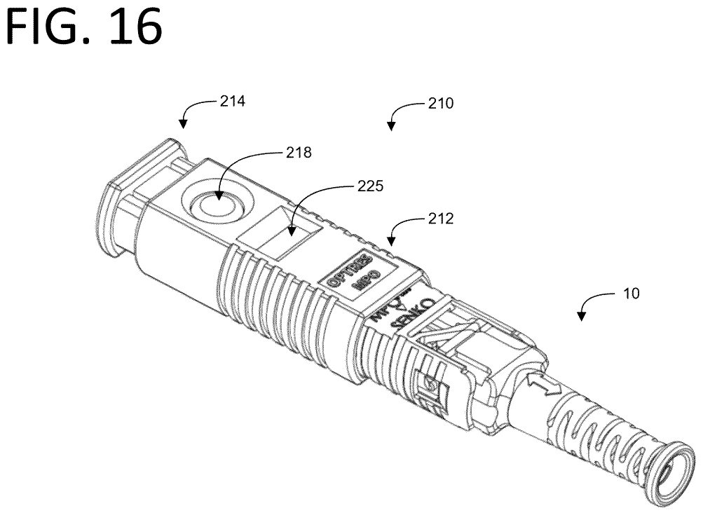

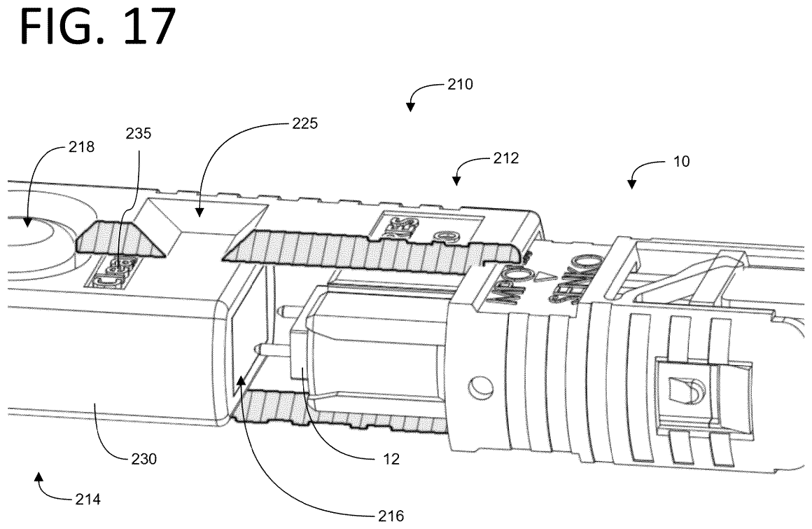

An example method of using the cleaning device 210 will now be described. Referring to FIGS. 16 and 17, the cleaning device 210 is assembled with the gel holder 214 and cleaning gel 216 positioned in the cleaning port 222 in the inactive position. An operator begins the cleaning process by inserting the fiber optic connector 10 into the connector port 220. In the inactive position, the activation button 218 is received in the button opening 223 to latch the gel holder 214 in position and inhibit movement of the gel holder 214. In this position, the ferrule 12 and guide pins are separated longitudinally from the cleaning gel 216.

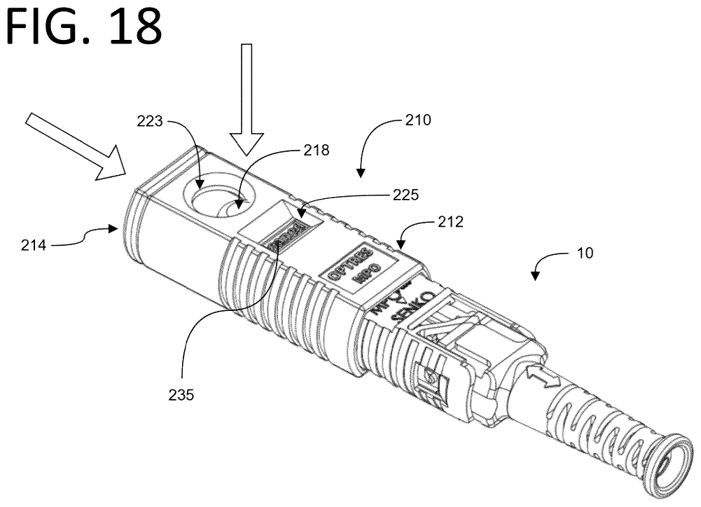

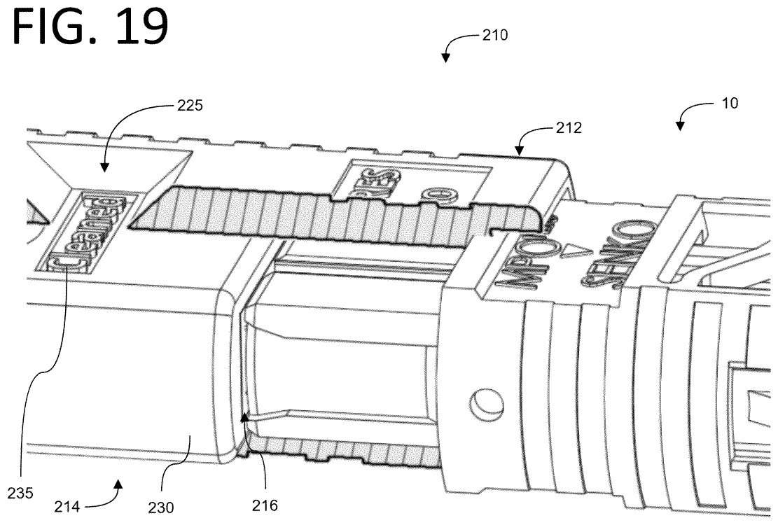

Referring to FIGS. 18 and 19, the operator activates the cleaning process by depressing the activation button 218 transversely. The transverse depression of the activation button 218 causes the bendable button arm 237 to flex, allowing the activation button 218 to unlatch from the button opening 223. This unlatching enables longitudinal movement of the gel holder 214 relative to the device housing 212.

With the activation button 218 unlatched from the button opening 223, the operator can press the head 232 to move the gel holder 214 longitudinally relative to the device housing 212. The gel holder 214 moves such that the insert 230 advances within the device housing 212 and the cleaning gel 216 engages the ferrule 12 and guide pins of the fiber optic connector 10 for cleaning. During this cleaning operation, the cleaning status indicator 235 becomes visible through the viewing window 225, providing visual feedback that the cleaning device 210 is in an active cleaning state and that the cleaning gel 216 is in contact with the ferrule 12. After cleaning is complete, the operator removes the fiber optic connector 10 from the connector port 220, with the connector now cleaned and ready for use.

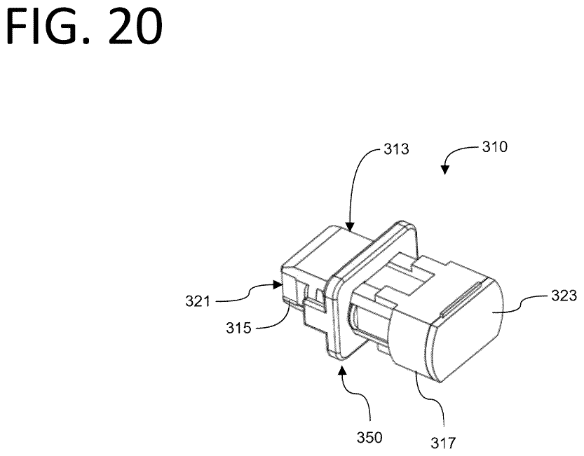

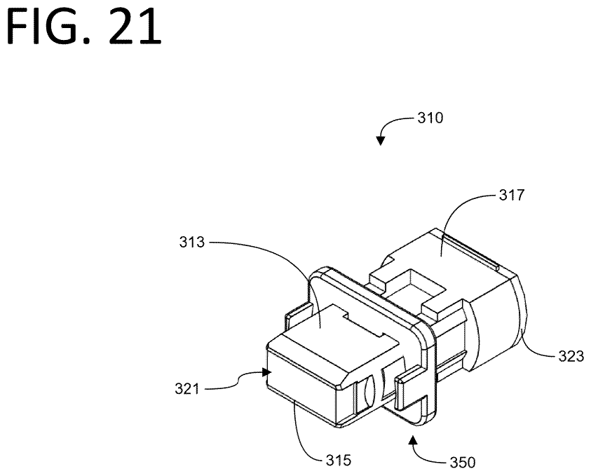

Referring to FIGS. 20-22, another example of a cleaning device in accordance with the present disclosure is generally indicated at reference number 310. The cleaning device 310 is configured for cleaning the end face of a multifiber ferrule 12 in an MPO fiber optic connector 10, but it will be understood that the principles of the cleaning device 310 described herein can also be adapted for use with other types of fiber optic connectors. The cleaning device 310 comprises a device housing 312, a first cleaning gel 321, a second cleaning gel 322, and a lock 350 configured to secure the device housing 312 to a fiber optic adapter 14. Unlike the previous device housings 112, 212, the illustrated device housing 312 does not define a connector port to mate directly with the fiber optic connector 10. Instead, as will be explained in further detail below, the illustrated cleaning device 310 is configured to clean a fiber optic connector 10 that is mated with a conventional fiber optic adapter 14. Further, the illustrated cleaning device 310 differs from the preceding cleaning devices 110, 210 in that it holds two cleaning gels 321, 322 at opposite ends of the device. As will be explained in further detail below, the first cleaning gel 321 is configured to clean the ferrule 12 of a fiber optic connector 10 mated in the adapter 14, whereas the second cleaning gel 322 is configured to clean the ferrule of a fiber optic connector outside the adapter.

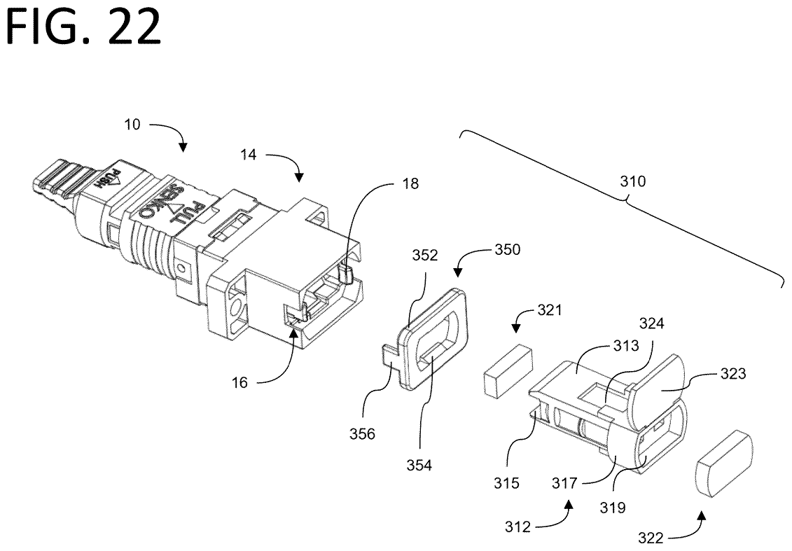

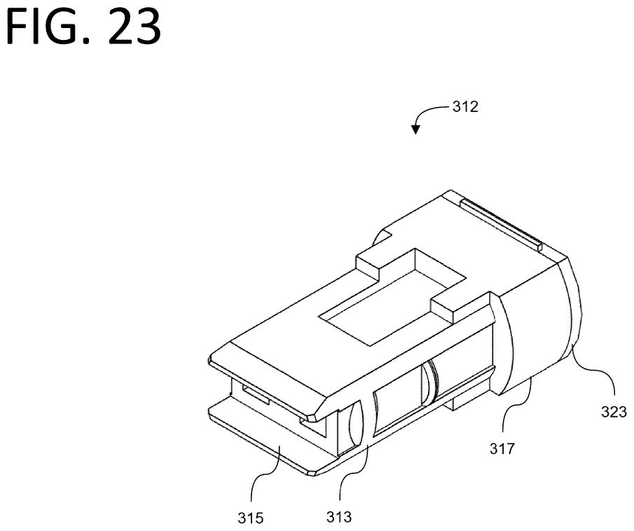

Referring to FIGS. 22 and 23, the device housing 312 has an elongated body structure extending longitudinally between first and second ends. The device housing 312 has a plug portion 313 configured to be inserted into one end of a fiber optic adapter 14. The plug portion 313 is positioned at the first end of the device housing 312 and includes features configured to mate with the fiber optic adapter 14. The device housing 312 comprises an internal gel seat 315 configured to be received inside the fiber optic adapter 14 when the plug portion 313 is inserted into the fiber optic adapter 14. The first cleaning gel 321 is positioned within the internal gel seat 315 and is configured to contact the ferrule 12 of a fiber optic connector 10 inserted into an opposite end of the fiber optic adapter 14 when the plug portion 313 is inserted into the fiber optic adapter 14. The internal gel seat 315 is formed within the plug portion 313 and defines a cavity sized and shaped to contain the first cleaning gel 321. A retention groove 324 is formed on an outer surface of the device housing 312 to facilitate connection to the lock 350. Another retention groove (not shown) is formed on an opposite outer surface of the device housing 312.

The device housing 312 further comprises a head 317 defining an external gel seat 319. The head 317 is positioned at the second end of the device housing 312 opposite the plug portion 313. The external gel seat 319 is formed within the head 317 and defines a cavity configured to receive the second cleaning gel 322. A lid 323 is configured to cover the external gel seat 319. In the illustrated embodiment, the lid 323 is hinged to provide movable access to the second cleaning gel 322 seated in the external gel seat 319. The hinged configuration of the lid 323 allows the lid 323 to be opened to expose the external gel seat 319 and the second cleaning gel 322 for cleaning operations, and closed to protect the second cleaning gel 322 when not in use. The head 317 and second cleaning gel 322 enable freehand cleaning by allowing a user to directly insert a fiber optic connector ferrule 12 into the external gel seat 319 for cleaning without requiring connection to an adapter.

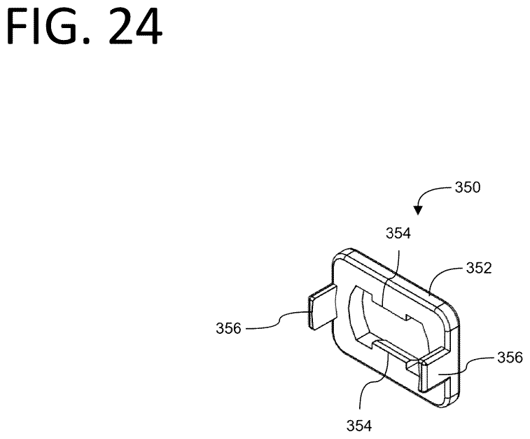

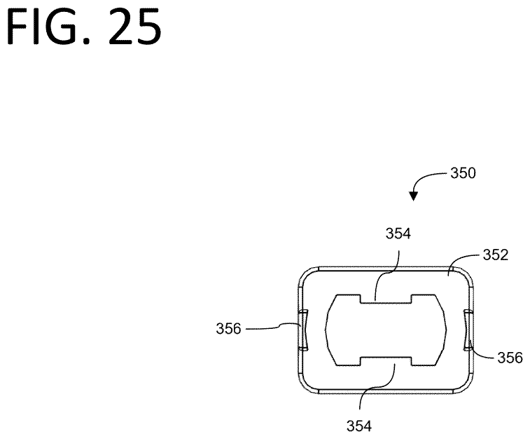

Referring to FIGS. 24 and 25, the lock 350 is configured to secure the device housing 312 to the fiber optic adapter 14. The lock 350 comprises a collar 352 having a generally rectangular configuration. The collar 352 includes latch protrusions 354 extending from opposite (upper and lower) sides of the collar 352. The latch protrusions 354 are configured to slidably engage the retention groove 324 to retain the lock 350 on the device housing 312. When the lock 350 is positioned on the device housing 312, the latch protrusions 354 are received in the retention grooves 324 and can slide longitudinally along the grooves to position the lock at an extended position and retracted position on the device housing 312. The lock 350 further includes locking arms 356 positioned on opposing (left and right) sides of the collar 352. During use, the lock 350 is retracted when the plug portion 313 is mated with the fiber optic adapter 14. Subsequently, the lock 350 can be extended to engage the locking arms 356 with the fiber optic adapter 14 to lock the cleaning device 310 in mated relation with the fiber optic adapter 14. More specifically, extending the lock 350 positions the locking arms 356 in notches 16 on the side walls of the adapter 14 to cover the MPO adapter latch arms 18. This locks the cleaning device 310 in the adapter 14 in a similar way to how a conventional MPO connector release sleeve does when an MPO connector is latched to the adapter. Accordingly, the locking arms 356 and plug portion 313 cooperate to provide secure attachment between the cleaning device 310 and the fiber optic adapter 14 during cleaning operations.

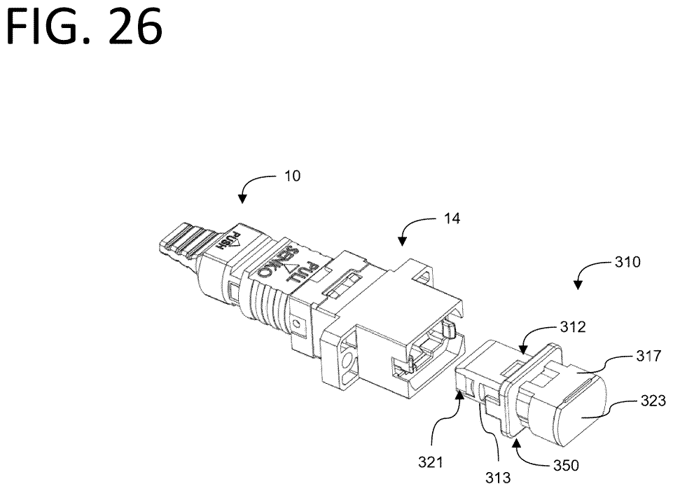

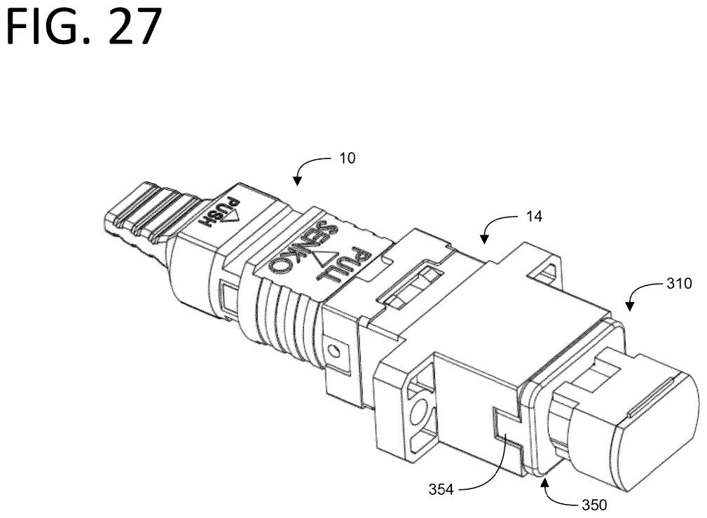

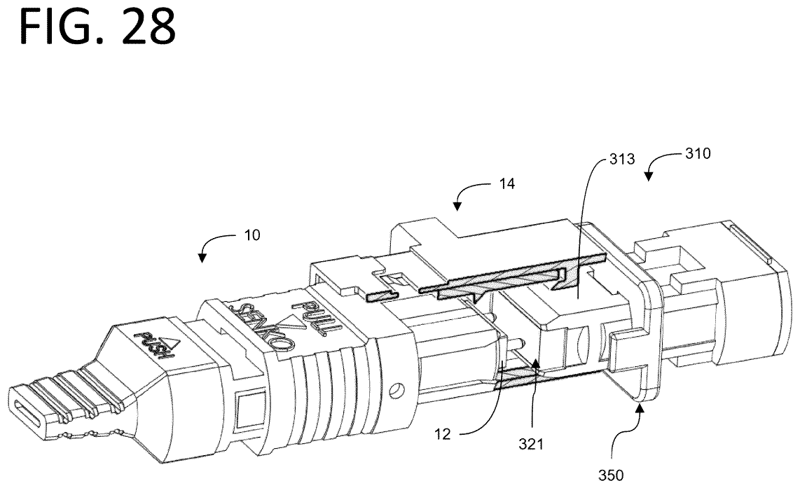

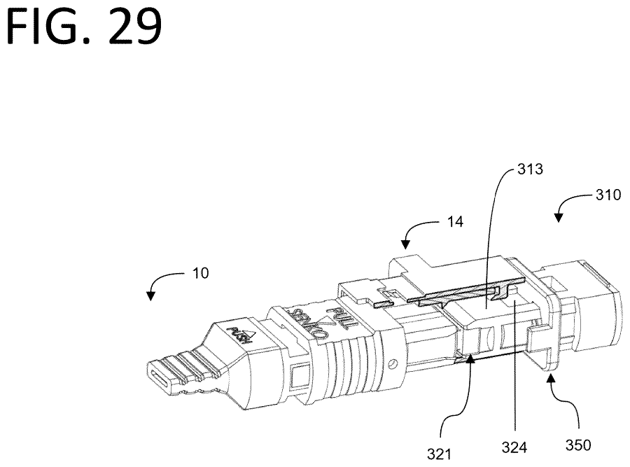

An example method of using the cleaning device 310 will now be described. Referring to FIGS. 26-29, the cleaning device 310 is assembled with the first cleaning gel 321 positioned within the internal gel seat 315 and the lock 350 positioned on the device housing 312. Initially, the lock 350 can be in a retracted position relative to the device housing 312. An operator begins the cleaning process by inserting the plug portion 313 into one end of the fiber optic adapter 14 and extending the lock 350 to secure the cleaning device 310 in the adapter. When the plug portion 313 is inserted into the fiber optic adapter 14, the internal gel seat 315 and first cleaning gel 321 are positioned inside the fiber optic adapter 14. The operator then inserts a fiber optic connector 10 into the opposite end of the fiber optic adapter 14, causing the ferrule 12 to contact the first cleaning gel 321 for cleaning. The fiber optic connector 10 can be removed from the adapter 14 when cleaning is complete.

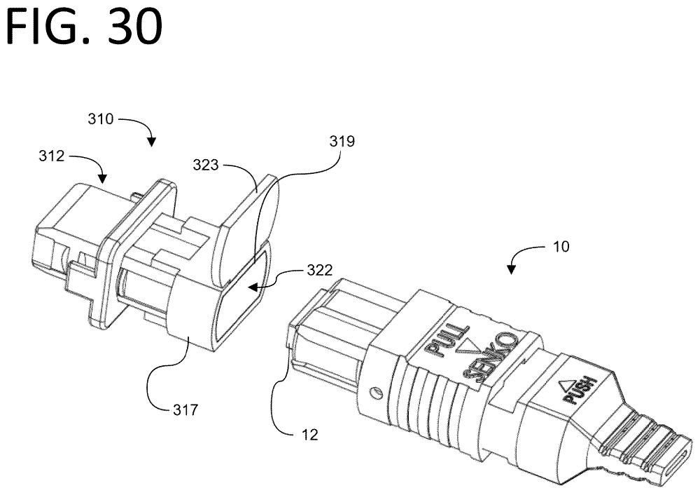

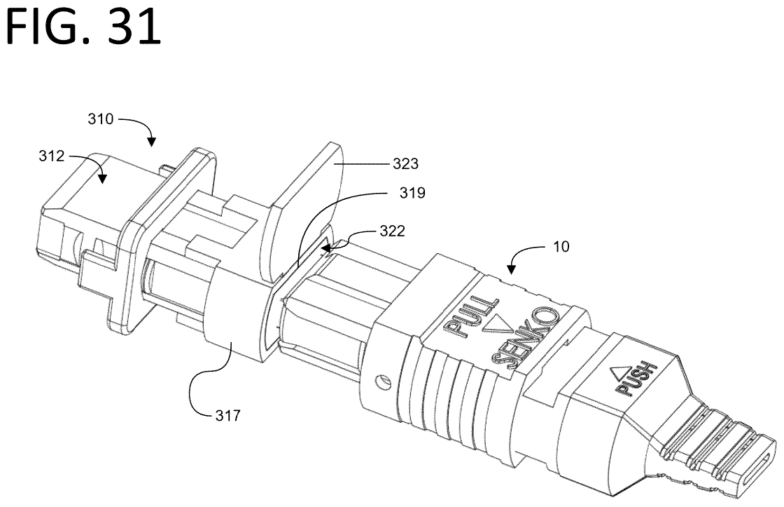

Referring to FIGS. 30 and 31, the cleaning device 310 may also be used for direct cleaning of fiber optic connectors 10 using the second cleaning gel 322. The operator lifts the lid 323 to expose the external gel seat 319 and second cleaning gel 322. With the lid 323 in the open position, the operator may insert the ferrule 12 of a fiber optic connector 10 directly into contact with the second cleaning gel 322 positioned within the external gel seat 319. This configuration allows for direct cleaning of the ferrule 12 without requiring connection to a fiber optic adapter 14. The cleaning device 310 provides dual cleaning functionality by enabling cleaning of connectors both through the fiber optic adapter 14 using the first cleaning gel 321 and directly on the fiber optic connector 10 using the second cleaning gel 322. After cleaning is complete using either cleaning method, the fiber optic connector 10 is ready for use.

The cleaning devices described herein may provide several benefits for maintaining fiber optic connector performance and network reliability. The cleaning devices may prevent contamination of connector ferrules during storage and shipping by providing protective cleaning gel that removes dirt, dust, and other particles from connector surfaces. By effectively cleaning connector end faces, the cleaning devices may reduce signal loss, minimize insertion loss, and decrease reflection that can otherwise degrade optical transmission quality. The cleaning devices may improve overall network performance by ensuring clean connections that maintain optimal signal integrity. The cleaning devices may offer convenient dry cleaning solutions that eliminate the need for separate wet cleaning procedures, providing users with efficient and effective cleaning capabilities in a single device. The dual-functionality cleaning devices may provide both adapter-based cleaning and direct connector cleaning options, offering versatility for different cleaning scenarios and maintenance requirements.

A number of implementations have been described. Nevertheless, it will be understood that various modifications may be made without departing from the spirit and scope of the disclosure. Accordingly, other implementations are within the scope of the following claims.

1. A cleaning device for cleaning fiber optic connectors, the cleaning device comprising:
a device housing having a connector port configured to receive a fiber optic connector having a ferrule;
a gel holder comprising an insert positioned within the device housing;
a cleaning gel supported on the insert and configured to contact the ferrule; and
an adjustable activation member configured to be adjusted to activate the gel holder to enable the gel holder to move relative to the device housing to engage the cleaning gel with the ferrule of the fiber optic connector mated with the connector port for cleaning.

2. The cleaning device of claim 1, wherein the adjustable activation member comprises an activation strip.

3. The cleaning device of claim 2, wherein the activation strip comprises a locking portion and a pull tab.

4. The cleaning device of claim 3, wherein the gel holder has an activation slot configured to receive the locking portion.

5. The cleaning device of claim 4, wherein the activation strip is configured to enable activation of the gel holder by pulling the pull tab to withdraw the locking portion from the activation slot.

6. The cleaning device of claim 1, wherein the gel holder comprises a head opposite the insert, the head being external to the device housing.

7. The cleaning device of claim 1, wherein the insert includes a latch protrusion and the device housing includes a retention groove located internally, the latch protrusion configured to slidably engage the retention groove and retain the gel holder on the device housing via engagement with the retention groove.

8. The cleaning device of claim 1, wherein the adjustable activation member comprises an activation button.

9. The cleaning device of claim 8, wherein the gel holder comprises a button arm supporting the activation button.

10. The cleaning device of claim 9, wherein the button arm is bendable.

11. The cleaning device of claim 8, wherein the device housing includes a button opening configured to receive the activation button to latch the gel holder in an inactive position relative to the device housing.

12. The cleaning device of claim 11, wherein the activation button is configured to be depressed transversely of the device housing to unlatch from the button opening and allow longitudinal movement of the gel holder relative to the device housing for cleaning.

13. The cleaning device of claim 8, further comprising a viewing window in the device housing.

14. The cleaning device of claim 13, further comprising a cleaning status indicator visible through the viewing window during cleaning.

15-20. (canceled)
